(19) United States
(12) Patent Application Publication
(10) Pub. No.: US 2010/0297423 A1
(43) Pub. Date: Nov. 25, 2010

(54) MAT ON WHICH TO PLACE ITEMS SOUGHT TO BE DRIED OR MAINTAINED DRY

(76) Inventors: Dean B. Chapman, New York, NY (US); Gareth Brown, Jersey City, NJ (US); Paul R. Goetz, Astoria, NY (US)

Correspondence Address: Thomas J. Brindisi , Esq.;Suite B, 20 28th Place, Venice, CA, 90291, US

(21) Appl. No.: 12/454,517

(22) Filed: May 19, 2009

(51) Int. Cl. B32B 3/26

(52) U.S. Cl. 428/304.4

(57) ABSTRACT

A mat on which to place items sought to be dried or maintained dry, comprising a bottom surface and an upper surface, the upper surface being interspersed with transversely and vertically-networked first voids having a size and configuration that permits horizontal and vertical air flow adjacent to an item placed on the upper surface, the mat also including second voids that permit vertical passage of liquid from the upper surface to the bottom surface. In a first embodiment, the mat includes a liquid-absorbing bottom layer at its bottom surface; in a second embodiment, the mat has a deformable upper surface.

### FIELD OF THE INVENTION

The present invention relates to devices for drying items, and more particularly, to a mat on which to place items sought to be dried or maintained dry.

### BACKGROUND

Various mats for protecting surfaces from items placed thereon are known (e.g., tablecloths such as described in German Patent No. 2,130,117 or European Patent No. 0096202) and various absorbent mats are known (such as U.S. Pat. No. 6,419,988), but Applicant is unaware of any device having voids that facilitate aeration of an item and voids that permit passage of liquid through the device, combined with either of the further synergistic features described in the following Summary.

### SUMMARY OF THE INVENTION

A mat on which to place items sought to be dried or maintained dry according to the present invention comprises a bottom surface and an upper surface, the upper surface being interspersed with transversely- and vertically-networked first voids having a size and configuration that permits horizontal and vertical air flow adjacent to an item placed on the upper surface, the mat also including second voids that permit vertical passage of liquid from the upper surface to the bottom surface. Applicant has found that the described voids foster an accelerated drying of an item placed on the mat.

The voids also combine synergistically with a further aspect of the invention, however: in a first embodiment, the further aspect is a liquid-absorbing bottom layer at the bottom surface of the mat; in a second embodiment, the further aspect is that the mat has a deformable upper surface. A synergy found by Applicant in the first embodiment is that adding a liquid absorbent layer below the described voids facilitates an enhancement of the accelerated drying created by the described voids—since the described voids can promote accelerated liquid drainage from an item placed on the mat, the liquid-absorbent layer at the mat's bottom helps collect liquid draining through the mat that could otherwise undesirably pool on the surface where a user places the mat. At the same time, the first voids promote evaporation so as to reduce the potential liquid load for the liquid-absorbent layer. Together, these features effectively provide an unexpectedly quick and clean drying of items placed on the mat.

A synergy believed to exist in the second embodiment is that while the described deformability helps secure items placed on the mat so that they are less prone to falling over or off the mat, the described voids nevertheless allow aeration in the bottom portion of an item to which draining liquid tends to drip, despite that portion actually impinging below the ordinary (non-deformed) upper plane of the mat's upper surface. (This synergy may also be created/enhanced by the voids' reducing and parsing the area of contact between the mat and an item so as to accelerate drippage from the item to the mat, despite the item impinging into the mat). The features of the first and second embodiments are not mutually exclusive, and can be combined in an embodiment exhibiting both advantages.

### BRIEF DESCRIPTION OF THE DRAWINGS

FIG. 1 is a sectional view, taken through line AA shown in FIG. 2, of a drying mat.

FIG. 2 is a top perspective view of the drying mat of FIG. 1.

FIG. 3 is a bottom perspective view of the drying mat of FIG. 1.

FIG. 4 is a perspective view of the drying mat of FIG. 1, showing the drying mat folded in half and snapped shut for compactness.

FIG. 5 is a top perspective view of the drying mat of FIG. 1, showing items placed on it for drying.

FIG. 6 is a sectional view of the drying mat of FIG. 1, showing an item placed on it for drying.

FIG. 7 is a perspective view of the drying mat of FIG. 1, showing the drying mat hung over a rail for drying of the drying mat.

FIG. 8 is a sectional view, taken through line BB shown in FIG. 9, of a drying mat like that of FIG. 1 but constructed with a mesh outer layer.

FIG. 9 is a top perspective view of the drying mat of FIG. 8.

FIG. 10 is a top perspective view of another version of a drying mat.

### DETAILED DESCRIPTION

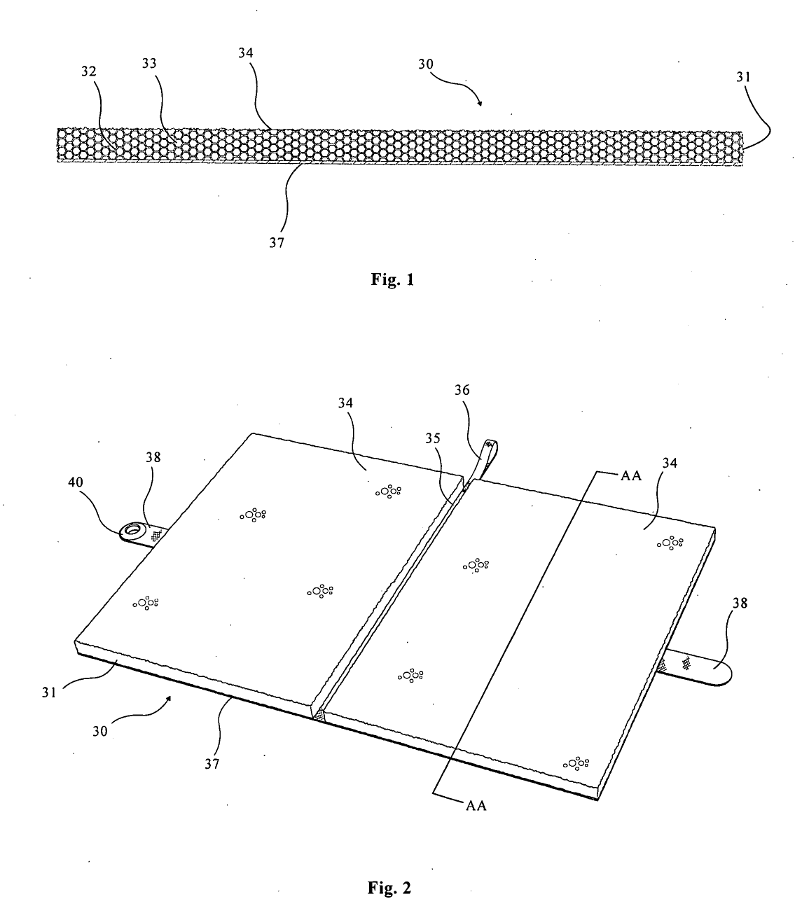

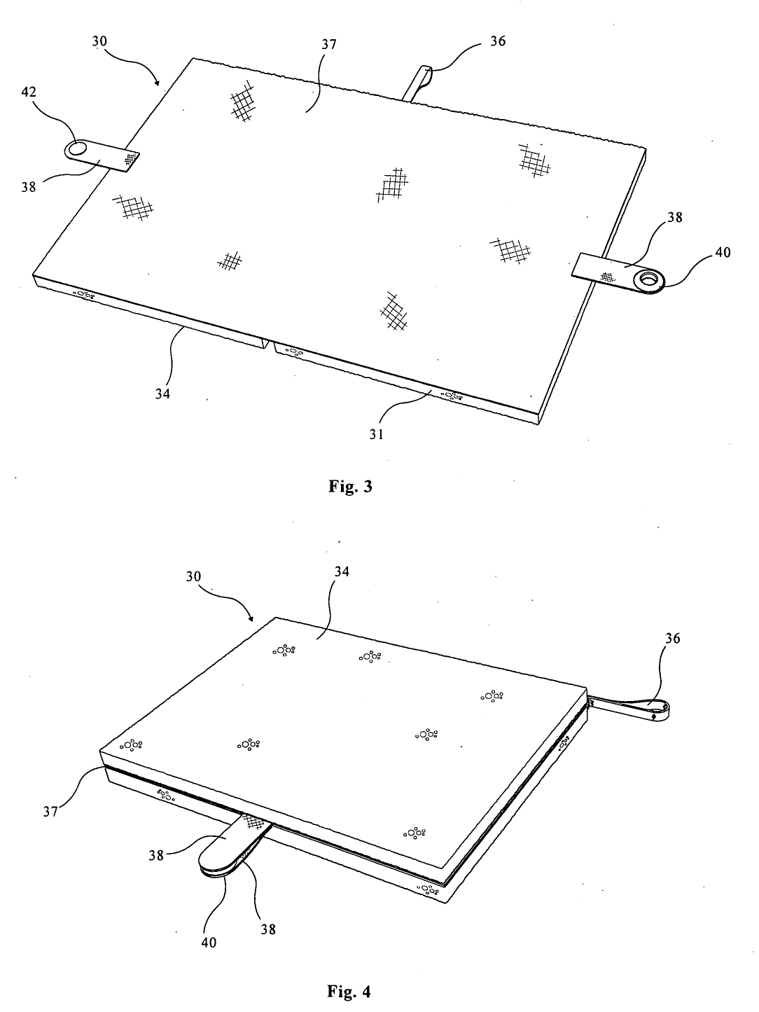

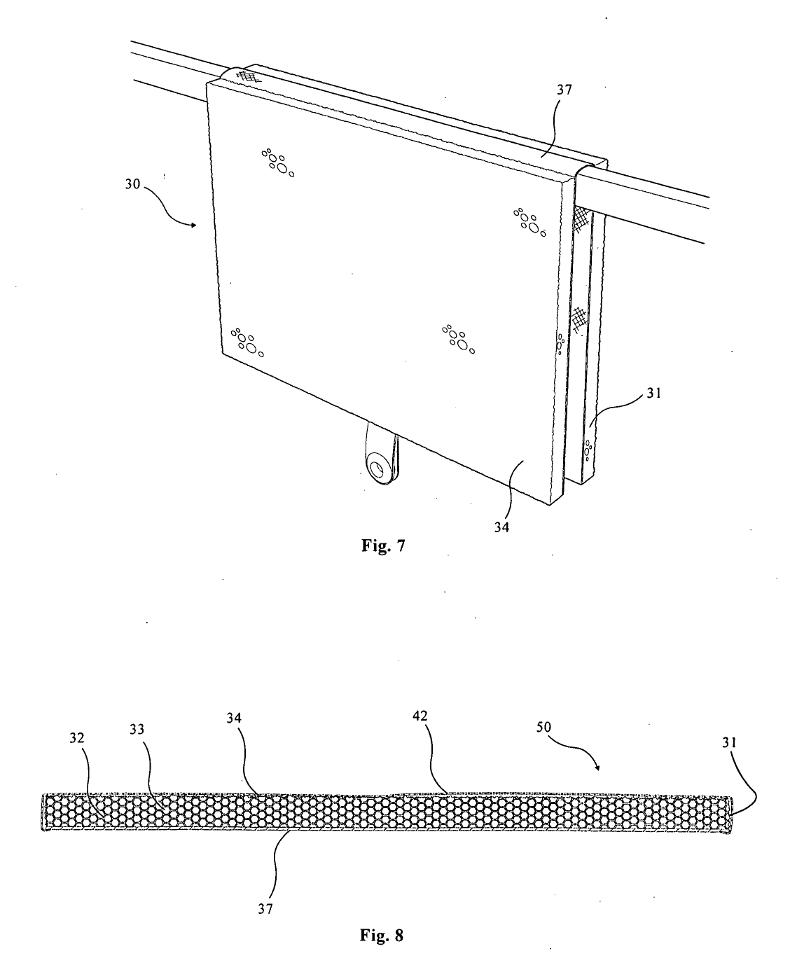

FIGS. 1-7 depict a drying mat 30 scaled and configured, as just noted, for drying dishes and utensils. For the sake of brevity of description, the drying mat 30 described here combines both the features of the first and second embodiments noted in the foregoing Summary. FIG. 1 shows a cross-section of the drying mat 30, which consists primarily of an upper layer 31 and a bottom layer 37. The upper layer 31 consists of a three-dimensional lattice 32 having an upper surface 34 and interspersed by a network of voids 33, and the (optional) bottom layer 37 (shown fully in FIG. 3) preferably comprises a highly liquid-absorbent material. As shown in FIG. 2, the upper layer 31 is divided (e.g., separately formed, cut, melted, relieved, etc.) into two halves at bifurcation 35 (or into more sections, e.g., quarters), permitting the drying mat 30 to fold in half as shown in FIGS. 4 and 7. As shown in FIG. 4, the drying mat 30 can then further be snapped shut with the ends of cloth tabs 38 attracted to one another by a magnet 42 and a metallic grommet 40, to keep the drying mat 30 in a compact state such as for storage. In this state, or open, the drying mat 30 can be hung by hang loop 36, and as shown in FIG. 7, it can be slung on its bifurcation 35 over a rail (such as on an oven door in a kitchen).

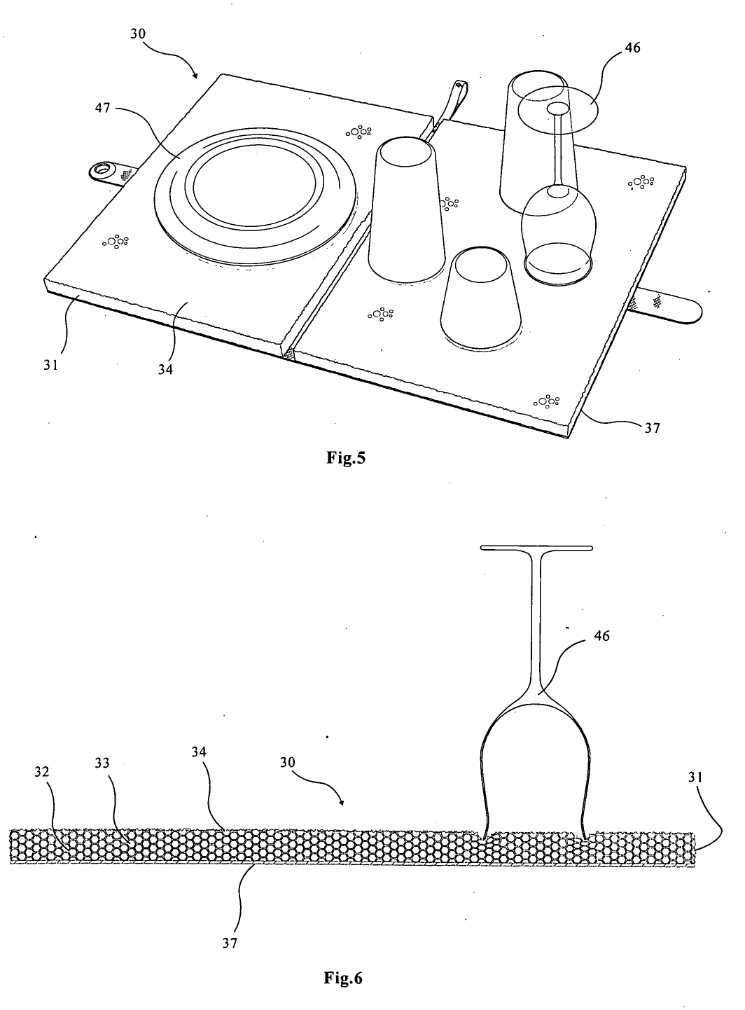

As shown in FIG. 5, in use, the drying mat 30 is laid on a flat surface, with the upper surface 34 facing up, and items that are desired to be dried (and/or maintained dry) such as glasses 46 and a dish 47 are placed atop the upper surface. The fundamental purposes of the network of voids 33 are aeration and draining. Regarding aeration, the voids 33 (at least in the region of the upper surface 34) preferably have a size and configuration such that when a wet item is placed on the upper surface 34, ambient air readily passes through them in the region adjacent (preferably around and under) the item, so that humid air can diffuse and waft away from the item thus speeding evaporation of liquid adhered to it, and possibly also so that air currents may help gravity overcome adhesion of liquid droplets on the item. (The reduction of the area of contact between an item and the lattice 32, which reduction corresponds to the extent of the voids 33, may also beneficially accelerate drippage from the item to the mat 30). Regarding draining, the voids 33 preferably have a size and configuration such that when a wet item is placed on the upper surface 34, liquid dripping downwardly from the item onto the upper surface 34 readily passes through the upper layer 31 to the (optional) bottom layer 37.

As shown in FIG. 6, the lattice 32 is also preferably (although not necessarily) formed of a material that moderately elastically deforms downwardly under the weight of an intended item in the immediate region where the item impinges on the upper surface 34 (in FIG. 6, the rim of the glass 46), preferably without transmitting that deformation substantially beyond the immediate region of impingement (so as to maintain stable support), thus helping to hold the item in place on the upper surface 34. Many suitable configurations depending on the application will be readily apparent to one of ordinary skill in the art, but Applicant has found that reticulated polyester polyurethane foam (Spec. No. PS-0089 manufactured by Crest Foam Industries of Moonachie, N.J.) ⅝ inch thick with about ten pores (voids) per linear inch (or about 1,000 per cubic inch) and a nominal density of about 1.9 pcf and having a CFD of about 0.45 psi at 25% deflection and an IFD of about 15-110 lbs at 25% deflection and a volumetric flow rate of about 23 cfm (each measured per ASTM D3574-91) serves well as the upper layer 31, providing good aeration and draining, as well as deformability, in the context of a mat 30 measuring fourteen by twenty-one inches intended for drying dishes and utensils. Alternately, the upper layer 31 might comprise another material such as polyethylene, nylon, natural or synthetic sponge, woven stainless steel, etc. To optimize drying, it is believed that aeration toward the upper surface 34 is benefited by transverse and vertical networking of voids 33, but that toward the bottom of upper layer 31, the voids 33 need not be as large or as transversely networked, since toward the bottom the purpose of the voids 33 increasingly becomes merely the passing of the comparatively small volumetric flow of drained liquid vertically down and out the bottom of upper layer 31. Consequently (not shown), an embodiment could be envisaged in which the voids 33, going from the top to the bottom of upper layer 31, decrease in volume and transverse networking (and correspondingly the lattice's elasticity may also decrease from top to bottom), or the upper layer 31 could be formed of two differently latticed/voided sub-layers.

The bottom layer 37 is preferably highly liquid absorbent so as to collect drained liquid, and as such could be a microfiber, woven bamboo cloth, hemp fiber, hemp/flax cloth organic cotton, ‘e-cloth’ (80% polyester/20% polyamide), or other suitable material. (Applicant's present preferred mode is a microfiber of 250 to 350 grams per square meter comprising 70% to 80% polyester and 20% to 30% nylon). The material for the bottom layer 37 preferably has a capacity to absorb at least its own weight in water, if not greater such as five or seven times its weight in water. After use, the drying mat 30 can then be slung over a rail or other suitable place where its bottom layer 37 can in turn be effectively drip- and/or air-dried. The bottom layer 37 may also be used to directly dry and or polish an item, if made of a suitable non-abrasive material.

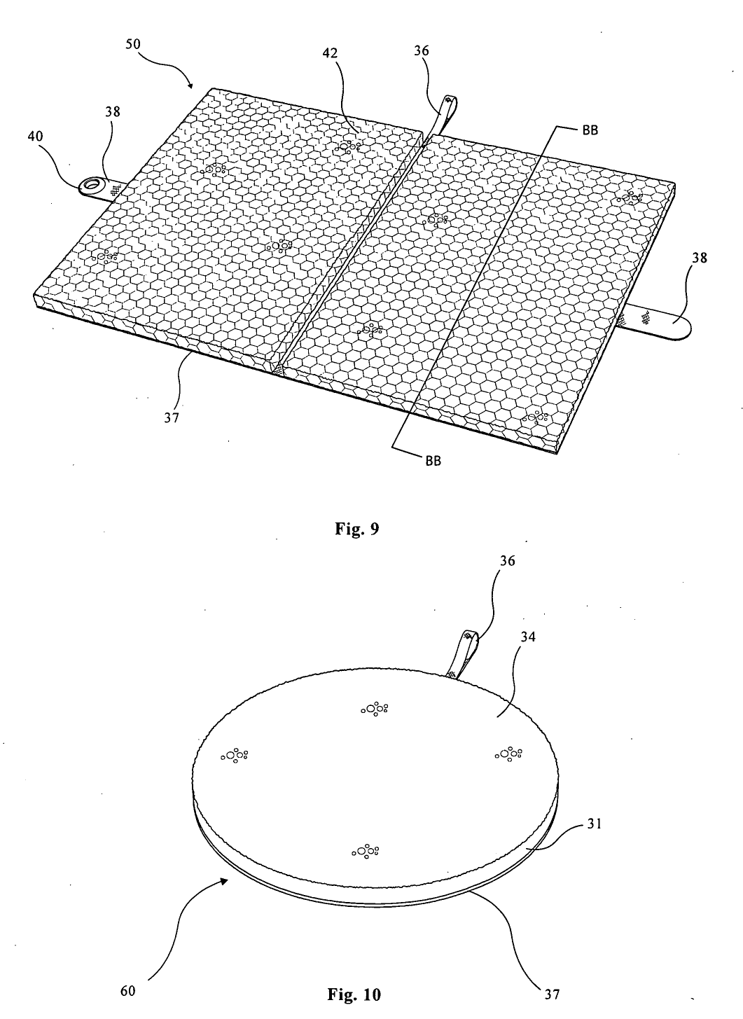

The upper layer 31 and bottom layer 37 can be permanently joined by a number of means well-known in the field, such as with stitching (Applicant's present preferred mode), by thermal bonding, by chemical adhesive, or they could be releasably joined such as by hooks-and-loops or snaps so as to permit washing one or both of the layers separately (e.g., hand-rinsing and shake- or wring-drying of the upper layer 31, and machine washing and drying of the bottom layer 37). Alternately, as shown in FIGS. 8 and 9, a modified drying mat 50 could be constructed by enclosing a drying mat as described above in a mesh 42 (e.g., a very thin nylon honeycomb, similar to that used in bags for containing delicate washables inside a washing machine but much lighter). The mesh 42 could be sewn to three sides of the bottom layer 37, the upper layer 31 inserted into the pocket formed thereby, and the fourth side of the bottom layer 37 sewn to the mesh 42 so as to hold the upper layer 31 in place against the bottom layer 37.

On suitable embodiments of the invention, optional surface features (e.g., debossed indentations shaped to accommodate utensils laid flat or to accommodate the circular rim of glasses, not shown) could also be provided to help secure desired items more stably, and patterns and/or prints (using, e.g., soy- or water-based inks) may be provided on one or both layers.

FIG. 10 depicts a slightly different version of a drying mat 60 that is round-shaped, for example to facilitate its placement in the bottom of a bowl (e.g., to enhance the drying of fruit after washing). In such an example, if the bottom surface of the type of bowl into which it is intended to be placed is not flat, the drying mat 60 may be made of material that generally conforms to the shape of the bowl's bottom, while there may be little or at least less benefit (although perhaps no drawback) to making the upper layer 31 of a material that would elastically deform significantly under the weight of intended items.

In fact, an embodiment of the invention (not shown) lacking a deformable upper layer (e.g., more suitable for drying cleaning tools) may have an upper layer that is rigid, such as honeycombed plastic providing a suitable air- and liquid-passing void network, (preferably removably) attached to a liquid-absorbent bottom layer. Conversely, an embodiment of the invention lacking a liquid-absorbent bottom layer may have a bottom layer that is rigid, formed of plastic, bamboo, stainless steel or other suitable material (such as in a vertical grating to allow continued downward passage of drained liquid) attached to a deformable upper layer such as the reticulated polyurethane foam described above. While the embodiments of at least FIGS. 1-9 include both the liquid-absorbent bottom layer and the deformable upper layer, this is for the sake of brevity of description, and Applicant does not regard the invention to require both. It is also noted that although the present detailed description focuses primarily on a scale and configuration well-suited for drying dishes and utensils such as in a kitchen, one of ordinary skill in the art will readily recognize that numerous variations, modifications, and a variety of other embodiments suitable for drying other kinds of items or materials in other situations are likewise within the scope and spirit of Applicant's invention. As an example, an embodiment such as that of FIGS. 1-9 if constructed of the noted example materials (i.e., a ⅝ inch, 10 pore per inch reticulated polyester polyurethane foam with a microfiber bottom layer), could be used and/or more specifically adapted to the drying of small delicate clothing items that are desirably dried laying flat, and in such case could also first be used to initially wring liquid out of the item by rolling the item within the mat and wringing the mat thereby driving liquid from the item through the foam and into the mat's liquid absorbent layer. Thus, the foregoing detailed description is not intended to limit the invention in any way, which is limited only by the following claims and their legal equivalents.

What is claimed is:

1. A mat on which to place items sought to be dried or maintained dry, said mat having a bottom surface and an upper surface, wherein said upper surface is interspersed with transversely- and vertically-networked first voids having a size and configuration that permits horizontal and vertical air flow adjacent to an item when placed on said upper surface, and wherein said mat also includes second voids that permit vertical passage of liquid from said upper surface to said bottom surface, said mat further comprising a liquid-absorbent layer attached to said bottom surface.

2. The mat of claim 1, wherein said first voids and said second voids are provided by a set of uniform voids having the same size and configuration from said upper surface to said bottom surface.

3. The mat of claim 1, wherein said upper surface is elastically compressible under the weight of an item sought to be dried or maintained dry when the item is placed on said upper surface.

4. The mat of claim 3, wherein said upper surface has a CFD of less than 2.5 psi at 25% deflection measured per ASTM D3574-91.

5. The mat of claim 3, wherein said upper surface has a CFD of less than 1 psi at 25% deflection measured per ASTM D3574-91.

6. The mat of claim 3, wherein said first voids permit a volumetric flow rate of at least 7.5 cfm measured per ASTM D3574-91.

7. The mat of claim 3, wherein said first voids permit a volumetric flow rate of at least 15 cfm measured per ASTM D3574-91.

8. The mat of claim 1, wherein said first voids comprise at least half of the volume of said mat at said upper surface.

9. The mat of claim 2, wherein said first voids comprise at least half of the volume of said mat at said upper surface.

10. The mat of claim 3, wherein said first voids comprise at least half of the volume of said mat at said upper surface.

11. A mat on which to place items sought to be dried or maintained dry, said mat having a bottom surface and an upper surface, wherein said upper surface is interspersed with transversely- and vertically-networked first voids having a size and configuration that permits horizontal and vertical air flow adjacent to an item when placed on said upper surface, and wherein said mat also includes second voids that permit vertical passage of liquid from said upper surface to said bottom surface, and wherein said upper surface is elastically compressible under the weight of an item sought to be dried or maintained dry when the item is placed on said upper surface.

12. The mat of claim 11, further comprising a liquid-absorbent layer attached to said bottom surface.

13. The mat of claim 12, wherein said first voids and said second voids are provided by a set of uniform voids having the same size and configuration from said upper surface to said bottom surface.

14. The mat of claim 11, wherein said upper surface has a CFD of less than 2.5 psi at 25% deflection measured per ASTM D3574-91.

15. The mat of claim 11, wherein said upper surface has a CFD of less than 1.25 psi at 25% deflection measured per ASTM D3574-91.

16. The mat of claim 11, wherein said upper surface has a CFD of less than 0.75 psi at 25% deflection measured per ASTM D3574-91.

17. The mat of claim 11, wherein said first voids permit a volumetric flow rate of at least 7.5 cfm measured per ASTM D3574-91.

18. The mat of claim 11, wherein said first voids permit a volumetric flow rate of at least 15 cfm measured per ASTM D3574-91.

19. The mat of claim 11, wherein said first voids comprise at least half of the volume of said mat at said upper surface.

20. The mat of claim 13, wherein said first voids comprise at least half of the volume of said mat at said upper surface.
